(19) United States
(12) Patent Application Publication
(10) Pub. No.: US 2025/0093750 A1
(43) Pub. Date: Mar. 20, 2025

(54) METHOD AND APPARATUS FOR IMPROVED FUNCTION AND REUSABILITY OF A DISPOSABLE CAMERA

(71) Applicant: Krumholz LLC, New York, NY (US)

(72) Inventor: Joseph Krumholz, New York, NY (US)

(73) Assignee: Krumholz LLC, New York, NY (US)

(21) Appl. No.: 18/889,080

(22) Filed: Sep. 18, 2024

Related U.S. Application Data
(60) Provisional application No. 63/538,924, filed on Sep. 18, 2023.

(51) Int. Cl. G03B 17/02; G03B 7/02; G03B 15/05

(52) U.S. Cl. CPC G03B 17/02; G03B 7/02; G03B 15/05; G03B 2215/0503

(57) ABSTRACT

A method is disclosed for enhancing the function of and reducing environmental impact of a disposable camera. The method may include assembling an apparatus, which may comprise an enclosure, a printed circuit board containing a light sensor, one or more reusable components, and a disposable camera. The apparatus may then be transferred to a user. After use, the apparatus may then be received and a film may be extracted from it, which may be developed into one or more photos. The apparatus may then be separated into component parts, with each part identified as reusable or unusable. The unusable components may then be disposed of via a disposal step, while the reusable components may be assembled again for future use. The developed photos may then be transferred to the user, and the unusable components may be transferred to a waste facility for proper disposal.

### TECHNICAL FIELD OF THE DISCLOSURE

The invention is related generally to the field of photography. More particularly, the invention relates to systems, methods, and apparatuses for improving the function and reusability of a disposable camera.

### INTRODUCTION

Disposable cameras offer a simple, convenient alternative to digital photography. However, many photos taken with disposable cameras ultimately fail to capture their intended subjects. Users of disposable cameras often operate with uncertainty as to the quality of their final images since present disposable cameras typically feature a manual flash and a standard shutter.

The standard mechanical shutter speed of typical disposable cameras does not allow for a user to adjust their photography for differing levels of light, often causing under exposure or over exposure of photos, both of which could be problematic for a person seeking to clearly capture images. In contrast to other methods of photography, the shutter of a presently available disposable camera is spring-loaded according to a standardized preset and released to open and subsequently close at a fixed speed once the user takes a photo. Because the speed of this shutter is fixed, more or less light than appropriate may be exposed to the film when users take photos.

Another issue that frequently leads to suboptimal photos taken by a disposable camera is that users often neglect to utilize the flash feature. Since the flash on presently available disposable cameras is a manually elected function, many users decline or forget to use this feature, leading to poor photo quality or “blank” photos with no image content upon developing.

One of the most concerning issues surrounding the use of disposable cameras is the negative environmental impact caused by the presently available options. Currently, each camera is designed for single use, resulting in a large number of cameras being discarded after a single roll of film is used. This leads to a significant amount of plastic and electronic waste. Moreover, the disposal of disposable cameras poses a challenge, as they are not easily recyclable due to the complex mix of materials used in their construction. Overall, the widespread use of disposable cameras has adverse effects on the environment, making it crucial to explore more sustainable alternatives in the field of photography.

It would therefore be desirable to have a disposable camera with an adjustable shutter speed, an automatic flash feature which activates based on environmental light levels, and a reuse program designed to minimize the environmental impacts of disposable camera use. The present disclosure overcomes the foregoing problems and others and enables users to capture photos in a wider variety of lighting environments, recycle the body of their disposable camera, and receive their photos.

### SUMMARY

Aspects of the present disclosure relate to a method for enhancing functionality and reducing an environmental impact of a disposable camera, the method including: an assembly step including: assembling an apparatus, including an enclosure, a printed circuit board containing a light sensor, one or more reusable components, and a disposable camera; an apparatus distribution step including: transferring the apparatus to a user; a return step including: receiving the apparatus; a processing step including: extracting a film from the apparatus, and developing the film into one or more developed photos; a recycling step including: separating the apparatus into a plurality of component parts, identifying each of the plurality of component parts as one of a reusable component or an unusable component, disposing the unusable component(s) via a disposal step, assembling the reusable component(s) via the assembly step; a photo distribution step including: transferring the one or more developed photos to the user; and the disposal step including: transferring each of the unusable component(s) to a waste facility.

Aspects of the present disclosure relate to a method, wherein the one or more reusable components are selected from the group consisting of a lens assembly, a shutter assembly, a film assembly, a flash bulb, a power assembly, an enclosure, a variable speed shutter, a printed circuit board, and components thereof.

Aspects of the present disclosure relate to a method, wherein the printed circuit board adjusts an operation of the flash bulb according to one or more environmental light conditions.

Aspects of the present disclosure relate to a method, wherein the printed circuit board is assembled from a plurality of circuit components selected from the group consisting of light sensors, analog-to-digital converters, microcontrollers, electronic contacts, optocouplers, traces, operational amplifiers, resistors, and capacitors.

Aspects of the present disclosure relate to a method, wherein the printed circuit board is configured to control the variable speed shutter, and wherein an operation speed of the variable speed shutter is automatically adjusted according to one or more environmental light conditions.

Aspects of the present disclosure relate to a method, wherein the apparatus is configured to be at least partially recycled by the recycling step.

Aspects of the present disclosure relate to a method, wherein the method further includes assembling, a variable speed shutter; and configuring the printed circuit board to control the variable speed shutter.

Aspects of the present disclosure relate to an enhanced light sensing disposable camera including at least an enclosure, a variable speed shutter, a printed circuit board, one or more reusable components, and a disposable camera, wherein the enclosure, variable speed shutter, printed circuit board, one or more reusable components, and disposable camera are assembled via an assembly step, wherein the one or more reusable components are received from a recycling step, wherein the printed circuit board is configured to detect an environmental light condition, and wherein the printed circuit board is configured to control the variable speed shutter based on the environmental light condition.

Aspects of the present disclosure relate to an apparatus, wherein the printed circuit board is assembled from a plurality of circuit components selected from the group consisting of light sensors, analog-to-digital converters, microcontrollers, electronic contacts, optocouplers, traces, operational amplifiers, resistors, and capacitors.

Aspects of the present disclosure relate to an apparatus, wherein the apparatus is configured to be at least partially recycled by the recycling step.

Aspects of the present disclosure relate to an apparatus, wherein the one or more reusable components are selected from the group consisting of a lens assembly, a shutter assembly, a film assembly, a flash bulb, a power assembly, an enclosure, a variable speed shutter, a printed circuit board, and components thereof.

Aspects of the present disclosure relate to an apparatus, wherein the printed circuit board adjusts an operation of the flash bulb according to the environmental light condition.

Aspects of the present disclosure relate to an apparatus, wherein the disposable camera is optionally a recycled disposable camera.

Aspects of the present disclosure relate to an enhanced light sensing disposable camera including at least: an enclosure, a variable speed shutter, a light sensor, a flash bulb, a printed circuit board, one or more reusable components, and a disposable camera, wherein the enclosure, variable speed shutter, printed circuit board, one or more reusable components, and disposable camera are assembled via an assembly step, wherein the one or more reusable components are received from a recycling step, wherein the printed circuit board is configured to detect an environmental light condition via the light sensor, wherein the printed circuit board is configured to control the variable speed shutter based on the environmental light condition, and wherein the printed circuit board is configured to control the flash bulb via an optocoupler based on the environmental light condition.

Additional embodiments and operations of the photography device and system are discussed in further detail in connection with the figures.

### BRIEF DESCRIPTION OF DRAWINGS

FIG. 1 is a high-level process flow diagram of the system according to aspects of the present disclosure.

FIG. 2 illustrates a disassembled exemplary embodiment of a disposable camera according to aspects of the present disclosure.

FIG. 3 is a process flow diagram of the assembly step according to aspects of the present disclosure.

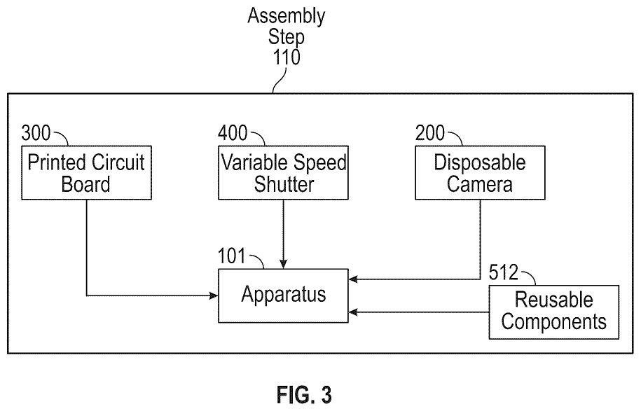

FIG. 4 is a perspective view of the apparatus according to aspects of the present disclosure.

FIG. 5 illustrates a printed circuit board according to aspects of the present disclosure.

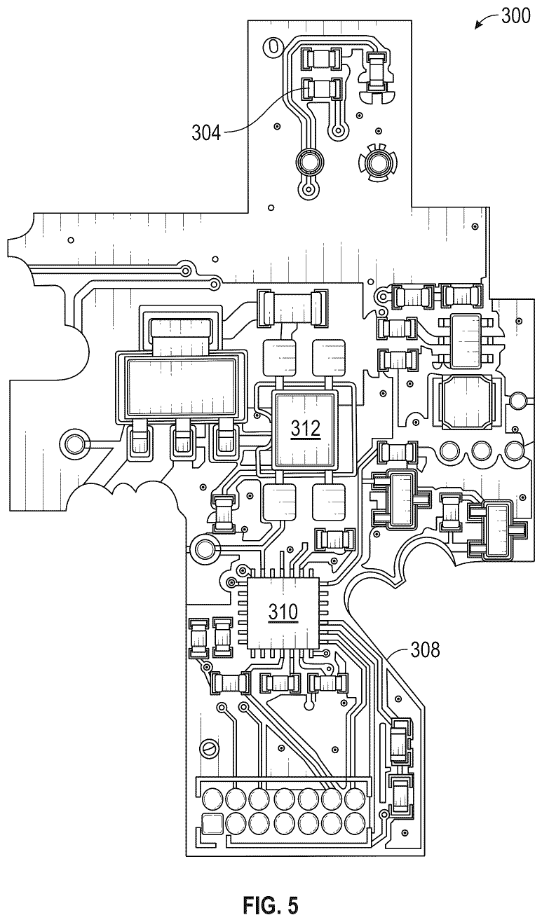

FIG. 6 is a perspective view of a front cover and back cover of the apparatus according to aspects of the present disclosure.

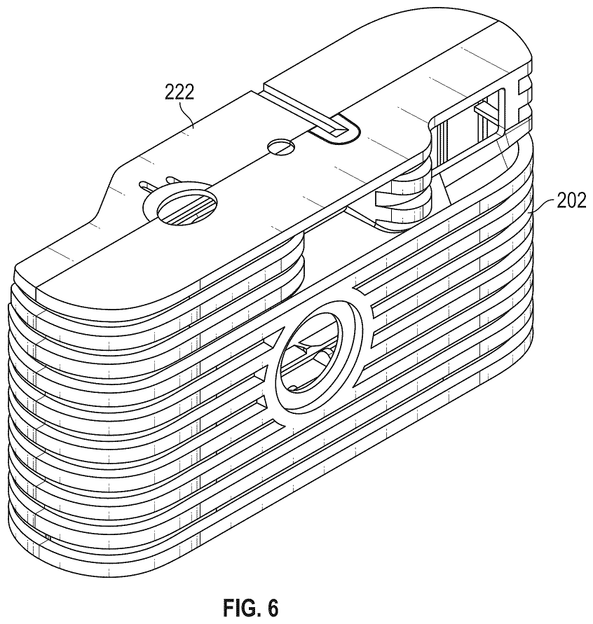

### DETAILED DESCRIPTION

Throughout the specification, wherever practicable, like structures will be identified by like reference numbers. In some figures, components, such as additional electrical connections or fasteners have been omitted for clarity in the drawings. Unless expressly stated otherwise, the term “or” means “either or both” such that “A or B” includes A alone, B alone, and both A and B together.

Although the present device and system has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

Aspects of the present disclosure may be used to capture consistent images using a disposable camera and may also be used to reduce the environmental impact of disposable camera use. The present disclosure may further be used to automatically adjust the shutter speed of a disposable camera, to automatically utilize a flash function, and to reuse components of a disposable camera multiple times.

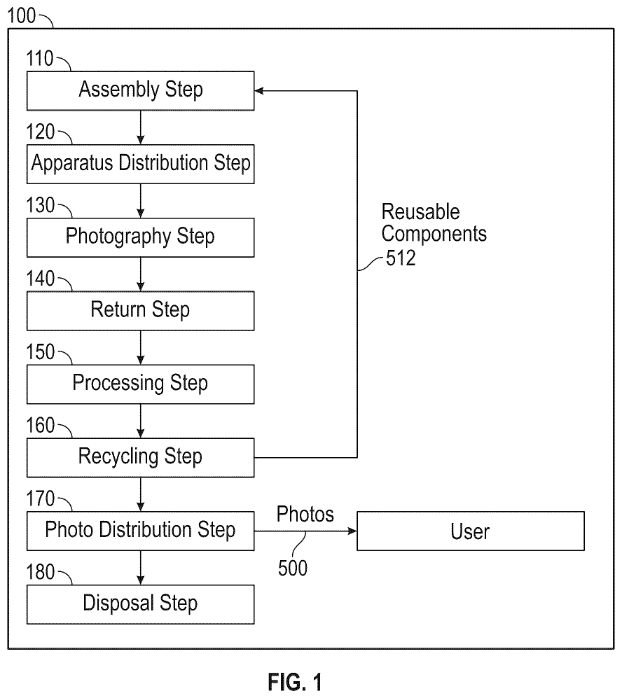

Turning to FIG. 1, aspects of the present disclosure relate to a method having a plurality of steps including an assembly step 110, an apparatus distribution step 120, a photography step 130, a return step 140, a processing step 150, a recycling step 160, a photo distribution step 170, and a disposal step 180. Each of the plurality of steps may be completed by a distributor. In an alternative embodiment, one or more of the plurality of steps may be completed by a user, or any suitable individual or organization. In a preferred embodiment, a distributor may complete the assembly step 110, the processing step 150, the recycling step 160, and/or the disposal step 180. Additionally, a distributor may initiate the apparatus distribution step 120 and the photo distribution step 170. In an embodiment, any of the plurality of steps may be carried out by a third party.

In an embodiment, the assembly step 110 may include constructing the apparatus 101 from a plurality of parts. In an embodiment, the plurality of parts include a disposable camera 200, a printed circuit board 300, and a variable speed shutter 400. The disposable camera 200 may be manufactured by a third party. In an alternative embodiment, parts of the disposable camera 200 may be manufactured with the apparatus 101.

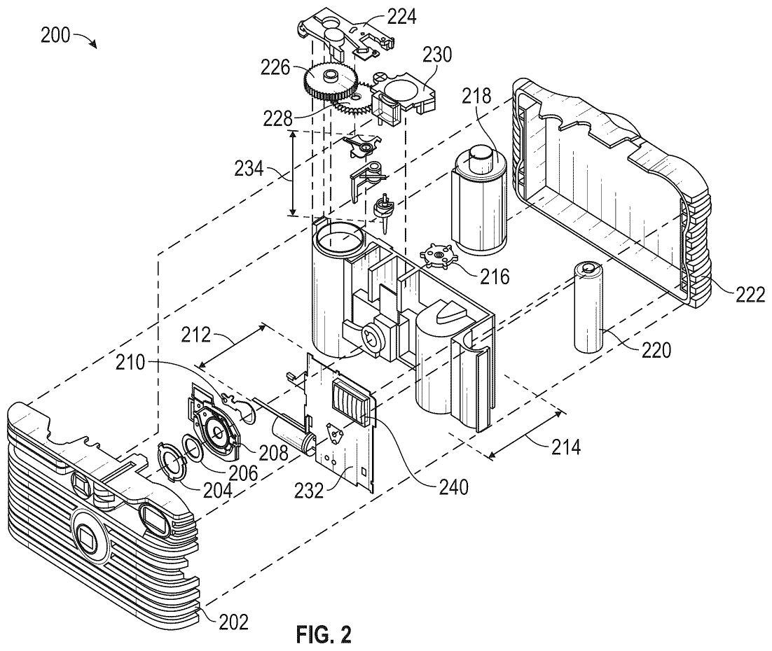

Turning to FIG. 2, the disposable camera 200 may be constructed from a plurality of component parts which may be generally described as a cover, a lens assembly, a shutter assembly, a film assembly, a flash unit 212, and a power assembly. In an embodiment, a cover may include a front cover 202 and a back cover 222. As a non-limiting example, a lens assembly may include a lens stopper 204, a plastic lens 206, a viewfinder 230, and a lens holder 208 and a shutter assembly may include a mechanical shutter 210, a shutter button 224, a central chassis 214, and a sprocket 216. In an embodiment, a film assembly may include a film 218, an advance wheel 226, a frame counter 228, and a cocking mechanism 234. In an embodiment, a power assembly may include a disposable camera circuit board 232, a battery 220, and a flash unit 212. In an embodiment, the flash unit 212 may further comprise a flash bulb 240 and a switch.

In an embodiment, the disposable camera 200 may comprise all of the aforementioned components. However, the disposable camera 200 may comprise only some of the aforementioned components. In another embodiment, the disposable camera 200 may comprise different components designed to serve a similar function (i.e. to capture photos on film using a single-use device). The disposable camera 200 may be configured to capture one or more photos 500, up to and including the maximum number of spaces on the film 218. The apparatus 101 may further comprise reusable components 512 designated during the recycling step 160.

In an embodiment, the assembly step 110 may require that the disposable camera 200 be separated into its components and fused, attached, or otherwise coupled to a printed circuit board 300 and a variable speed shutter 400. As a non-limiting example, the printed circuit board 300 may be electronically coupled to the disposable camera circuit board 232. As a non-limiting example, the mechanical shutter 210 may be removed from the disposable camera 200 and replaced with a variable speed shutter 400. Further, the assembly step 110 may utilize reusable components 512 from the recycling step 160. The reusable components 512 may be repurposed for multiple iterations of the process 100. As a result, the process 100 may have lower environmental impact and overall cost to the consumer than presently available photography methods.

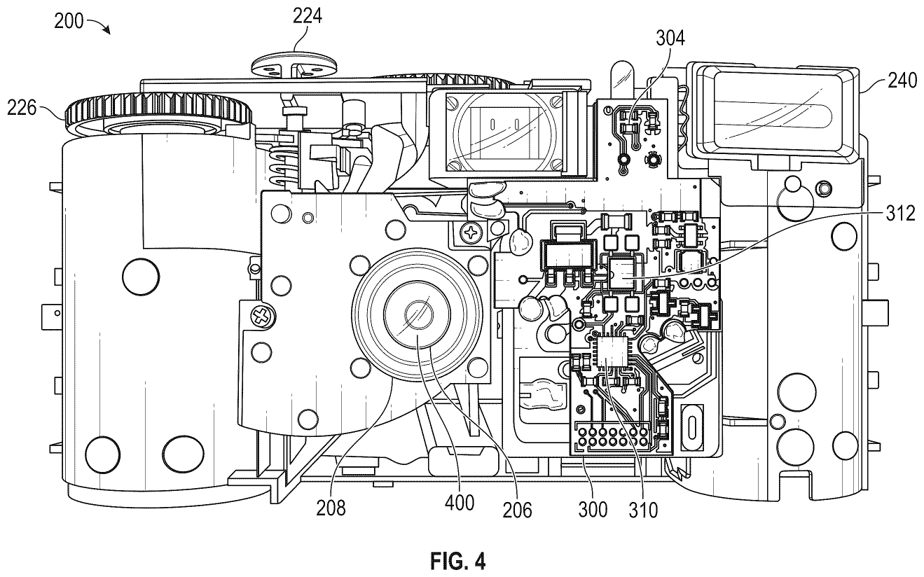

Referring to FIG. 4, the apparatus 101 may comprise a printed circuit board 300. The printed circuit board 300 may be configured to interface with one or more components of the disposable camera 200. As a non-limiting example, the printed circuit board may be configured to avoid impeding the functions of the disposable camera 200. In an embodiment, the printed circuit board 300 may be fused or electronically coupled to the disposable camera circuit board 232. In another embodiment the disposable camera circuit board 232 may be replaced by a single printed circuit board 300. The single printed circuit board 300 may be configured to entirely replace the disposable camera circuit board 232 and may include all the components and functionality of the disposable camera circuit board 232.

The printed circuit board 300 (described in more detail below) may be retrofit into the disposable camera 200. In an embodiment, the printed circuit board 300 may be connected to the disposable camera circuit board 232. In such an embodiment, a multi-layer circuit board may be formed. For example, the printed circuit board 300 may be connected to the disposable camera circuit board 232 via a connector. In yet a further embodiment, the connector may enable electrical transmission between the printed circuit board 300 and the disposable camera circuit board 232, such that both boards may work in unison upon the printed circuit board 300 being retrofit onto the disposable camera circuit board 232.

The printed circuit board 300 may be configured to accept input from the battery 220 and a light sensor 304 and may be configured to control output to at least a flash bulb 240. The light sensor 304 may function as an input device and may detect ambient light conditions around the apparatus 101. The light sensor 304 may be connected to the printed circuit board 300, which may serve as the central control unit. As a non-limiting example, the signal from the light sensor 304 may cause, via the microcontroller 310, the flash bulb 240 to flash upon the shutter button 224 being depressed. In an embodiment, the light sensor 304 may dictate the shutter speed of the variable speed shutter 400 based on the sensed ambient lighting conditions. For example, the shutter speed may be variably reduced if the light intensity decreases, and variably increased if the light intensity increases.

The printed circuit board 300 may comprise various electronic components, including but not limited to one or more traces 308, microcontrollers 310, and optocouplers 312, as well as other requisite electronic components including analog-to-digital converters (ADC's), amplifiers, resistors, inductors, transformers, diodes, transistors, switches, relays, electronic contacts, and capacitors to electrically couple the same. These electronic components may work together to process incoming signals from the light sensor 304 and generate appropriate output signals to activate or otherwise control a flash bulb 240 and/or a variable speed shutter 400.

During the photography step 130, the light sensor 304 may measure the intensity of the environmental light. The signal from the light sensor 304 may be transmitted via the trace 308 which may be present on the printed circuit board 300. The signal may be analyzed by the microcontroller 310 which may be present on the printed circuit board 300. The microcontroller 310 may compare the signal to a flash threshold value, which may be a predetermined light intensity level at which the microcontroller 310 may cause the flash bulb 240 to flash upon the shutter button 224 being depressed as described in greater detail below.

In an embodiment, if environmental light is at or below a flash threshold value, indicating low light conditions, the microcontroller 310 may send a signal to the optocoupler 312. The optocoupler 312 may drive a current to the flash bulb 240, activating it and emitting light to ensure a clear and properly exposed photo. The microcontroller 310 may be configured to send a signal to the flash bulb 240 via the optocoupler 312 only upon a user's interaction with the shutter button 224, provided the environmental light is at or below the flash threshold value. In another embodiment, the microcontroller 310 may be configured to send a signal to the flash bulb 240 via the optocoupler 312 upon activation of a manual switch (not shown). Said manual switch may be disposed upon the front cover 202. In such an embodiment, the manual switch may be configured to at least one of an active position and a passive position. In an embodiment, the manual switch may be manually actuated by the user, such that the manual switch is easily interchangeable from the active position to the passive position, and vice versa. As a non-limiting example, when the manual switch is in the active position, the microcontroller 310 may send a signal to the optocoupler 312, wherein the optocoupler 312 drives a current to the flash bulb 240 upon the user's interaction with the shutter button 224. In another non-limiting example, when the manual switch is in the passive position, the microcontroller 310 may not send a signal to the optocoupler 312, such that the optocoupler 312 is unable to drive a current to the flash bulb 240 upon the user's interaction with the shutter button 224.

In an embodiment, if environmental light is above the flash threshold value, indicating sufficient ambient light conditions, the microcontroller 310 may suppress the signal to the optocoupler 312, which may in turn prevent the flash bulb 240 from activating. This intelligent control mechanism ensures that the flash bulb 240 is only activated when necessary to provide additional light in a photo, conserving energy, extending the lifespan of the flash bulb 240, and encouraging more consistent photography. The addition of an automated flash feature may improve the typically limited function of a disposable camera without compromising any of the convenience or economic benefits of such photography method. Further, the addition of an automated flash feature may allow inexperienced photographers to capture appropriately lit photos.

In an embodiment, the apparatus 101 may comprise a variable speed shutter 400. The variable speed shutter 400 may comprise one or more planar members which may be configured to cover the lens 206. The variable speed shutter 400 may be configured to move between an open position and a closed position at a varied speed according to the environmental light conditions. The variable speed shutter may receive a signal from the printed circuit board 300. In an embodiment, the printed circuit board 300 may control the movement of the variable speed shutter 400. As a non-limiting example, the variable speed shutter 400 may open for a brief period of time if the light sensor 304 detects a high level of environmental light. As another non-limiting example, the variable speed shutter may open for a relatively longer period of time if the light sensor 304 detects a lower level of environmental light. Since the light sensor 304 detects environmental light levels and sends a signal to modify the speed of the variable speed shutter 400, a user who takes photos with the apparatus 101 may be able to capture consistently-exposed photos in a variety of lighting conditions.

As a non-limiting example, in bright environments, the light sensor 304 may send a signal to the printed circuit board 300 or a component thereof indicating a high level of environmental light. The printed circuit board 300 or a component thereof may receive the bright light signal from the light sensor 304 and may send a command to the variable speed shutter 400 to open and close quickly, resulting in a shorter exposure time. This may limit the amount of light reaching the film 218 and may prevent overexposure of a photo 500.

As another non-limiting example, in low-light conditions, the light sensor 304 may send a signal to the printed circuit board 300 or a component thereof indicating a low level of environmental light. The printed circuit board 300 or a component thereof may receive the low-light signal from the light sensor 304 and may send a command to the variable speed shutter 400 to open and close at a slower speed. The slower operation of the variable speed shutter 400 may extend the exposure time and allow more light to reach the film 218, which may avoid underexposure of the resultant photo 500. The addition of a variable speed shutter 400 and a light sensor 304 may widen the set of conditions under which clear, properly-exposed photos may be captured using a semi-disposable camera. Moreover, the variable speed shutter 400 and the light sensor 304 may decrease a barrier to entry into photography for inexperienced users. For example, as opposed to manually adjusting the exposure, which requires vast amounts of practice and experience to produce properly-exposed photos 500, the light sensor 304 in conjunction with the variable speed shutter 400 enables the user to consistently produce properly-exposed photos 500 without any experience or practice.

As another non-limiting example, in an ultra-low light environment, the light sensor 304 may send a signal to the printed circuit board 300 or a component thereof which is below the flash threshold value, the printed circuit board 300 or a component thereof may send a signal to activate the flash bulb 240. In such conditions, the microcontroller 310 may also adjust the speed the variable speed shutter 400 to compensate for the additional light supplied by the flash bulb 240.

The variable speed shutter 400 may be integrated into the body of a disposable camera 200. The printed circuit board 300 may be the central control for both the variable speed shutter 400 and the flash bulb 240. The apparatus 101 may be configured to capture one or more consistently exposed photos 500 on film 218.

To accommodate its components, the apparatus 101 may consist of a custom-manufactured enclosure. The enclosure may consist of a front cover 202 and a back cover 222. In an embodiment, the enclosure may be configured to accommodate the components of a disposable camera 200 as well as the printed circuit board 300 and the variable speed shutter 400. In an embodiment, the enclosure may be designed to encourage a more ergonomic grip of the apparatus 101. As an illustrative example, the front cover 202 and the back cover 222 may be configured to allow the light sensor 304 to detect light levels of an environment. As another illustrative example, the enclosure may be sized or otherwise configured to accommodate any appropriate combination of component parts known in the art.

Once assembled, the apparatus 101 may be distributed to one or more users via the apparatus distribution step 120. The apparatus distribution step 120 may comprise any suitable means of distribution (e.g. brick and mortar retail, online orders, etc.). Once one of the one or more users receive the apparatus 101, the one or more users may enter the photography step 130. In an embodiment, the photography step may enable one or more users to capture photos 500 with the apparatus 101. The photography step 130 may be executed by winding the advance wheel 226 to move the film 218 into position, aiming the apparatus 101, and pressing the shutter button 224 to capture a photo. When the shutter button 224 is pressed, the apparatus 101 may utilize the light sensor 304 to detect environmental light levels, and via the printed circuit board 300, adjust the speed of operation of the variable speed shutter 400 and/or activate the flash bulb 240. In an alternative embodiment, motion of the advance wheel 226 may trigger the light sensor 304 to collect lighting data. As a non-limiting example, the photography step 130 may conclude at the user's discretion, or when the film 218 is fully at capacity with the photos 500.

In an embodiment, at the conclusion of the photography step 130, the return step 140 may enable the user to ship or otherwise transport the apparatus 101 to one of a plurality of return facilities. The return step 140 may comprise any suitable means of transport (e.g. brick and mortar retail, postal shipping, third party carriers, etc.). Once one of the one or more return facilities receive the apparatus 101, one of the one or more return facilities may engage in the processing step 150. In an embodiment, the processing step 150 may comprise a step in which the one or more photos 500 captured by the user in the photography step 130 are developed into physical prints, negatives, digital images, or any other suitable medium to be distributed in the photo distribution step 170. In an embodiment, the processing step 150 may require that the film 218 be removed from the apparatus 101 and developed into images according to methods known in the art.

After the processing step 150, the apparatus 101 may enter the recycling step 160. In an embodiment, a member of the staff at the return facility may separate the apparatus 101 into a plurality of component parts, may designate one or more reusable components 512 for re-entry into the process at the assembly step 110, and may designate one or more unusable components for the disposal step 180. As a non-exhaustive list, the one or more unusable components may comprise used film, extinguished flash bulbs, or electrical components in need of repair. As a non-limiting example, the one or more reusable components 512 may comprise any combination of the front cover 202, the lens stopper 204, the lens 206, the lens holder 208, the mechanical shutter 210, the flash unit 212, the central chassis 214, the sprocket 216, the film 218, the battery 220, the back cover 222, the shutter button 224, the advance wheel 226, the frame counter 228, the viewfinder 230, the disposable camera circuit board 232, the cocking mechanism 234, the printed circuit board 300, the variable speed shutter 400, or any component thereof. As a non-limiting example, the one or more reusable components 512 may re-enter the system in the assembly step 110.

Upon conclusion of the recycling step 160, the system may engage in the photo distribution step 170. In an alternative embodiment, the photo distribution step 170 may immediately follow the processing step 150. The photo distribution step 170 may comprise transmitting, transporting, or otherwise sharing the one or more photos 500 with the user. The photo distribution step 170 may be accomplished via electronic mail, internet file transfer, cloud-based file transfer, postal mail, or any other suitable method known in the art.

In an embodiment, the system may comprise a disposal step 180. The disposal step may require that the unusable components designated during the recycling step 160 are properly disposed of. As a non-limiting example, the unusable components may be transferred to third-party recycling companies or disposed according to any suitable method known in the art.

While this invention has been described in conjunction with the embodiments outlined above, many alternatives, modifications and variations will be apparent to those skilled in the art upon reading the foregoing disclosure, such as with other single use photography devices. Accordingly, the embodiments of the invention, as set forth above, are intended to be illustrative, not limiting. Various changes may be made without departing from the spirit and scope of the invention.

What is claimed is:

1. A method for enhancing functionality and reducing an environmental impact of a disposable camera, the method comprising:
an assembly step comprising:
assembling an apparatus, including an enclosure, a printed circuit board, one or more reusable components, and a disposable camera,
the printed circuit board being comprised of at least one of:
a light sensor configured to measure an environmental light intensity,
a microcontroller, and
an optocoupler;
an apparatus distribution step comprising:
transferring the apparatus to a user;
a return step comprising:
receiving the apparatus;
a processing step comprising:
extracting a film from the apparatus, and
developing the film into one or more developed photos;
a recycling step comprising:
separating the apparatus into a plurality of component parts,
identifying each of the plurality of component parts as one of a reusable component or an unusable component,
disposing of the unusable component(s) via a disposal step,
assembling the reusable component(s) via the assembly step;
a photo distribution step comprising:
transferring the one or more developed photos to the user; and
the disposal step comprising:
transferring each of the unusable component(s) to a waste facility.

2. The method of claim 1, wherein the one or more reusable components are selected from the group consisting of a cover, a lens assembly, a shutter assembly, a film assembly, a flash bulb, a power assembly, an enclosure, a variable speed shutter, a printed circuit board, and components thereof.

3. The method of claim 2, wherein the printed circuit board adjusts an operation of the flash bulb according to the environmental light intensity.

4. The method of claim 3, wherein the light sensor, measuring the environmental light intensity, sends a first signal to the microcontroller.

5. The method of claim 4, wherein the microcontroller analyzes and compares the first signal to a flash threshold.

6. The method of claim 5, wherein when the first signal is at or below the flash threshold, the microcontroller sends a second signal to the optocoupler, wherein the optocoupler drives a current to the flash bulb.

7. The method of claim 5, wherein when the first signal is above the flash threshold, the microcontroller sends a second signal to the optocoupler, wherein the optocoupler suppresses the second signal.

8. The method of claim 1, wherein the printed circuit board is assembled from a plurality of circuit components selected from the group consisting of the light sensor, analog-to-digital converters, the microcontroller, electronic contacts, the optocoupler, traces, operational amplifiers, resistors, and capacitors.

9. The method of claim 1, wherein the printed circuit board is configured to control a variable speed shutter, and wherein an operation speed of the variable speed shutter is automatically adjusted according to one or more environmental light conditions.

10. The method of claim 1, wherein the apparatus is configured to be at least partially recycled by the recycling step.

11. The method of claim 1, wherein the method further includes assembling a variable speed shutter; and
configuring the printed circuit board to control the variable speed shutter.

12. The method of claim 1, further comprising:
a photography step, between the apparatus distribution step and the return step, the photography step comprising:
capturing one or more photos.

13. An enhanced light sensing disposable camera comprising at least an enclosure, a variable speed shutter, a printed circuit board, one or more reusable components, and a disposable camera,
wherein the enclosure, variable speed shutter, printed circuit board, one or more reusable components, and disposable camera are assembled via an assembly step,
wherein the one or more reusable components are received from a recycling step,
wherein the printed circuit board is configured to detect an environmental light condition, and
wherein the printed circuit board is configured to control the variable speed shutter based on the environmental light condition.

14. The enhanced light sensing disposable camera of claim 13, wherein the printed circuit board is assembled from a plurality of circuit components selected from the group consisting of light sensors, analog-to-digital converters, microcontrollers, electronic contacts, optocouplers, traces, operational amplifiers, resistors, and capacitors.

15. The enhanced light sensing disposable camera of claim 13, wherein the enhanced light sensing disposable camera is configured to be at least partially recycled by the recycling step.

16. The enhanced light sensing disposable camera of claim 13, wherein the one or more reusable components are selected from the group consisting of a cover, a lens assembly, a shutter assembly, a film assembly, a flash bulb, a power assembly, an enclosure, a variable speed shutter, a printed circuit board, and components thereof.

17. The enhanced light sensing disposable camera of claim 16, wherein the printed circuit board adjusts an operation of the flash bulb according to the environmental light condition.

18. The enhanced light sensing disposable camera of claim 16, wherein the disposable camera is optionally a recycled disposable camera.

19. An enhanced light sensing disposable camera comprising at least:
an enclosure,
a light sensor,
a flash bulb,
a printed circuit board, and
one or more reusable components,
wherein the enclosure, printed circuit board, one or more reusable components, and disposable camera are assembled via an assembly step,
wherein the printed circuit board is configured to detect an environmental light condition via the light sensor, and
wherein the printed circuit board is configured to control the flash bulb via an optocoupler based on the environmental light condition.
